(19) United States
(12) Patent Application Publication
(10) Pub. No.: US 2003/0010426 A1
(43) Pub. Date: Jan. 16, 2003

(54) Method for increasing structural capacity of towers

(76) Inventor: James D. Lockwood, Dayton, OH (US)

Correspondence Address: Alan F. Meckstroth, JACOX, MECKSTROTH & JENKINS, Suite 2, 2310 Far Hills Building, Dayton, OH, 45419-1575, US

(21) Appl. No.: 10/193,014

(22) Filed: Jul. 11, 2002

Related U.S. Application Data
(60) Provisional application No. 60/304,688, filed on Jul. 11, 2001.

(51) Int. Cl. B65H 81/00; B32B 35/00

(52) U.S. Cl. 156/187; 156/71; 156/191; 156/94

(57) ABSTRACT

An improved method of structurally upgrading existing steel monopole or lattice tower structures insitu consists of bonding fiber reinforced polymer (FRP) composite materials to the existing steel member or component surfaces. A structural adhesive is used to bond the composite material directly to steel and transfers the load between the two materials in shear. Steel includes galvanized steel, steel alloy, cortan steel and other painted or unpainted structural steel. Tower includes a monopole tower or a utility or transmission tower made of plate steel or a lattice of structural members or components. The result is a synthesized tower structure that is stronger and stiffer than the original steel tower.

### BACKGROUND OF THE INVENTION

Existing methods to upgrading steel towers require bolting or welding of heavy steel members which is difficult to position and install. When existing steel is galvanized, welding can often damage the galvanizing at locations that are not practical to repair later. The present invention utilizes lightweight materials that can be installed without the need for heavy equipment and does not damage the structure when the retrofit reinforcement is completed.

The elimination of heavy equipment and welding in the field provides cost savings in the labor and capital required to reinforce a tower. The elimination of field welding also eliminates the risk of welding sparks dropping onto areas away from the tower and causing damage to property.

The completed retrofit reinforcement is low profile, meaning that no major projections exist from the tower when work is complete. Beyond the aerodynamic advantages, this has benefits to tower owners who have concerns about the aesthetic impact to the existing tower structure. For cellular communication towers in local communities, changes to a tower's appearance often requires the need for a new permit by a local or state permitting board.

### SUMMARY OF THE INVENTION

Strengthening Material

The FRP system applied in accordance with the invention can be a precured laminate, wet layup fabric, or prepreg fabric.

Precured Laminate

The fibers used to manufacture the laminates are typically carbon fiber, but other fibers may be used, including fiberglass. The laminate is adhered to the steel tower using epoxy adhesive that is applied as a secondary operation to manufacturing the laminate. Epoxy adhesive is applied directly to the side of a precured laminate as a paste or is applied using an epoxy saturated strip that rolls out onto the laminate. When applied as an adhesive strip, a peel ply may be used on the outside surface which is removed prior to laminate installation. Depending on the color of the tower, the laminate may be painted or covered with a veil that is the same color as the tower.

Wet Layup System

Dry unidirectional or multidirectional fiber or fabric strips are impregnated on site with a saturating resin. The strips bond to the steel surface and to one other by the saturating resin and cure under ambient temperature.

Prepreg System

A saturating resin is preimpregnated into strips of unidirectional or multidirectional fibers or fabrics at the supplier's facility. These strips may be bonded to the surface with or without additional resin application. The prepreg system may be cured using ambient temperature or water to accelerate catalization of the resin.

Application of FRP Material

The description of the process is written for monopole towers which are tapered and have multiple flat sides. Lattice towers are built with angular or circular structural shapes.

Process for Laminates

Typically, unidirectional carbon fiber laminates are delivered to the tower site in coiled strips (over 200 ft of laminate) or in plank-like strips of approx. 50 ft in length, depending on the laminate thickness.

Coils of strips are difficult to manage where laminate thickness exceeds 2 mm. Monopole towers are typically upwards of 100 to 200 ft. in height and have typically 12 or 8 flat tapered sides.

### BRIEF DESCRIPTION OF THE DRAWINGS

FIG. 1 is a perspective view of a tapered steel monopole tower having reinforcing strips applied in accordance with the invention;

FIG. 2 is an enlarged fragmentary section of the tower, taken generally on the line 2-2 of FIG. 1;

FIG. 3 is a fragmentary section of a tower section connection with overlapping reinforcing strips, taken generally on the line 3-3 of FIG. 1;

FIG. 4 is a fragmentary section of the tower and connection of reinforcing strips, taken generally on the line 4-4 FIG. 1;

FIG. 5 is a fragmentary perspective view of a precured laminate with an adhesive strip attached and a peel ply.

FIG. 6 is a fragmentary section of a tower having an adhesively applied fabric barrier veil;

FIG. 7 is a fragmentary section of a tower having a vertically applied fibrous reinforcing strip supplied from a roll; and

FIG. 8 is a fragmentary section of a tower having a helically wrapped fibrous reinforcing strip over the veil shown in FIG. 6.

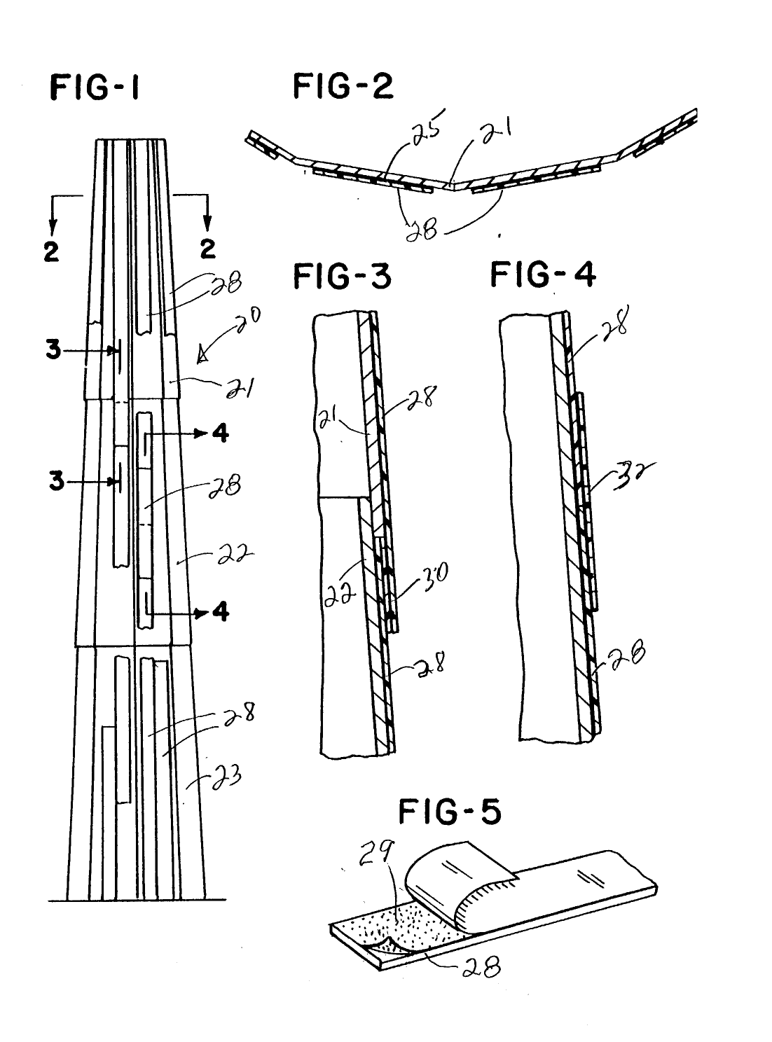

### PREFERRED METHOD OF APPLICATION FOR LAMINATE STRIPS

A hollow steel tower 20 is constructed in overlapping tapered sections 21, 22 and 23, and the outer surface is cleaned with a solvent that removes grit and grime. If galvanized, a solvent is used that can be applied to galvanizing or grit blast top 1 to 2 mm of galvanizing. If galvanizing is of poor quality, the galvanizing is removed by using grit blasting.

Epoxy adhesive 25 is applied to the sanded side of a laminate material or strip 28 to a thickness of no less than 1/16 to 1/8 inch and full width. The strip is then pressed onto a side of the steel tower 20, preferably using a pressure of approx. 50 to 100 psi. The epoxy adhesive 25 may also be applied directly to steel tower 20 in lieu of laminate prior to installing. A fabric material (wet layup or prepreg) may also be pulled around the tower under pressure at regular intervals.

As an alternative, an adhesive strip 29 (FIG. 5) is applied to the precured laminate 28 or the steel tower prior to applying pressure. The adhesive strip may be precut having the width and length of the laminate planks. This application method may be cleaner to manage on site and controls the thickness of the epoxy layer better than applying epoxy manually to a laminate face. A plastic or wax paper peel ply may be used to protect the tacky side of the prepreg material until just prior to adhering to a tower surface.

The length of the laminate strip applied to the tower along one continuous face may be limited as required to manage handling. In this case, the laminate strip may be spliced (FIG. 3) over one another using a strip 30 and structural adhesive to transfer the load in shear between laminates.

Splicing of laminates may be accomplished by staggering adjacent laminates along a face of the tower or using a splice plate 32 (FIG. 4) placed on top of the joint between laminates. Where a splice plate is used, the surfaces of the laminate receiving epoxy should be sanded. A splice that requires overlapping of existing laminates across a steel tower joint (FIG. 3) can also be used. In this case, the laminate is built up to transfer loads across the joint.

An epoxy adhesive layer should exist between carbon laminates and galvanized steel to prevent galvanic reaction between these two materials. The application of prepreg or wet layup strips described above will assist in controlling the thickness of this layer.

A veil or ultraviolet resistant paint may be required if the carbon laminates are not protected from the weather.

### Preferred Method of Application for Fabric Strips

A strip material comprises a multidirectional prepreg or wet layup fiberglass sheet and unidirectional carbon tow sheet. The fiberglass strip is saturated with resin and applied between the steel tower and the carbon tow sheet to prevent a galvanic action between the steel and carbon material. A veil or ultraviolet resistant paint is used to conceal and protect the outside layer of carbon.

The steel tower is cleaned with a solvent that removes grit and grime. If galvanized, a solvent is used that can be applied to galvanizing. If the tower was poorly galvanized, removal of galvanizing may be required by grit blasting.

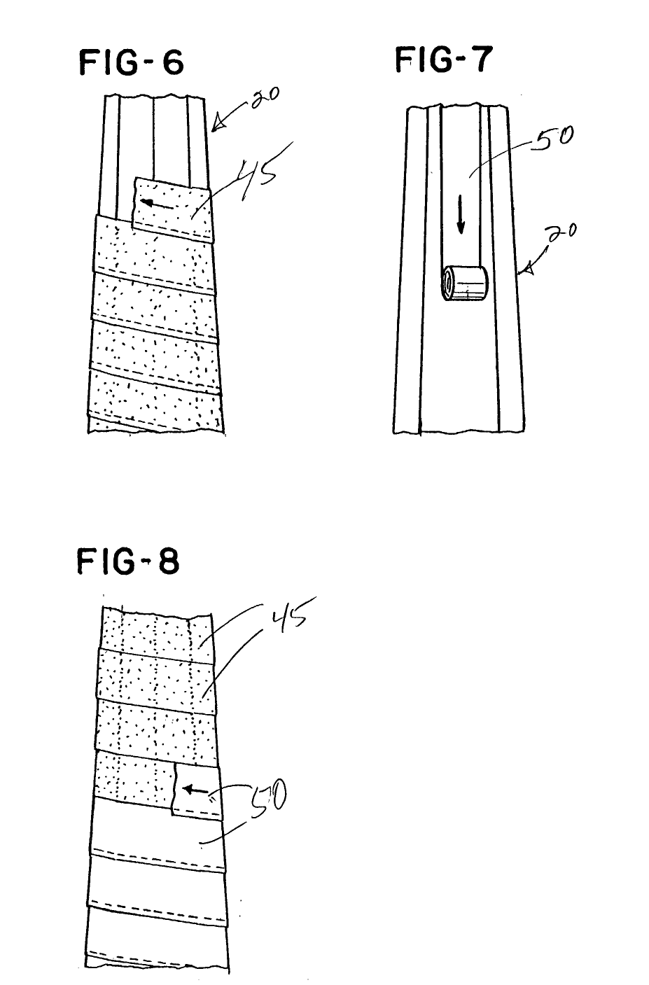

A fiberglass strip 45 is bonded or adhered to the steel tower by helically wrapping the strip (FIG. 6) around the perimeter of the pole or placing the strip vertically. The purpose of this strip is to establish a barrier between the steel pole and a carbon strip placed vertically (FIG. 7) or helically (FIG. 8).

The unidirectional carbon strip 50 is placed onto the tower over the layer of fiberglass strip 45 so that the unidirectional fibers are running upwards and downwards or generally vertically. On average, the strip width is 24 inches wide.

After a sufficient number of layers are applied for strength, a veil or protective ultra violet resistant paint that matches the color of the tower is applied for aesthetic and protective purposes.

### Structural Advantages

The application of precured laminates or of strips of sheet or fabric materials along the vertical axis of the tower strengthens the tower in tension and compression and stiffen the tower structure, reducing the PxDelta bending effect on the tower due to high flexibility at the tower's top. Since the failure of a steel monopole tower is typically one of local sheet buckling, the application of continuous FRP materials bonded to the steel in accordance with the invention results in an increase in the local buckling capacity and improves non-compact sections to compact sections.

I claim:

1. A method of increasing the structural capacity of a generally vertical tower having a generally vertical steel component, comprising the steps of forming at least one elongated strip having elongated fibers, and adhesively bonding the strip to the steel component with at least some of the fibers extending generally vertically.

2. A method as defined in claim 1 wherein the strip comprises a pre-impregnated fabric.

3. A method as defined in claim 1 wherein the fibers comprise carbon fibers.

4. A method as defined in claim 1 wherein the fibers comprise fiberglass fibers.

5. A method as defined in claim 1 wherein the strip is adhesively bonded to the steel component by an epoxy adhesive.

6. A method as defined in claim 1 wherein the strip comprises unidirectional elongated fibers impregnated with an adhesive resin.

7. A method as defined in claim 1 wherein the strip comprises multidirectional elongated fibers impregnated with an adhesive resin.

8. A method as defined in claim 1 and including a woven fibrous veil disposed between the steel component and the strip.

9. A method as defined in claim 1 wherein the strip is helically wrapped around the tower.

10. A method of increasing the structural capacity of a generally vertical monopole tower having generally vertical tapered steel faces, comprising the steps of forming at least one elongated strip having elongated fibers, and adhesively bonding the strip to a steel face with at least some of the fibers extending generally vertically.

11. A method as defined in claim 10 wherein the strip comprises a pre-impregnated fabric.

12. A method as defined in claim 10 wherein the fibers comprise carbon fibers.

13. A method as defined in claim 10 wherein the fibers comprise fiberglass fibers.

14. A method as defined in claim 10 wherein the strip is adhesively bonded to the steel face by an epoxy adhesive.

15. A method as defined in claim 10 wherein the strip comprises unidirectional elongated fibers impregnated with an adhesive resin.

16. A method as defined in claim 10 herein the strip comprises multidirectional elongated fibers impregnated with an adhesive resin.

17. A method as defined in claim 10 and including a woven fibrous veil disposed between the steel face and the strip.

18. A method as defined in claim 10 wherein the strip is helically wrapped around the tower.
